(19) United States
(12) Patent Application Publication
(10) Pub. No.: US 2007/0239750 A1
(43) Pub. Date: Oct. 11, 2007

(54) Communication screening system and method

(75) Inventor: Robert Boger, Sioux City, IA (US)

Correspondence Address: GATEWAY, INC.;ATTN: Patent Attorney, 610 GATEWAY DRIVE, MAIL DROP Y-04, N. SIOUX CITY, SD, 57049, US

(73) Assignee: Gateway

(21) Appl. No.: 11/394,284

(22) Filed: Mar. 30, 2006

(51) Int. Cl. G06F 7/00

(52) U.S. Cl. 707/101

(57) ABSTRACT

A database includes class fields that can designate contacts in relationship to the database owner, so that when incorporated into the logic of a communication device, the logic can be configured to automatically determine how a communication from that contact is routed. The database thus allows contacts to be sorted by certain criteria or classes. These criteria or classes could include Co-Worker, Boss, Emergency Contact, Family, Friends, etc. The logic can optionally be configured to assign or permit assignment of different priorities to different classes in the database.

### BACKGROUND OF THE INVENTION

1. Field of the Invention

The present invention relates to devices, systems, and processes useful for screening electronic communications between communications devices, and more specifically to screening telephone calls.

2. Brief Description of the Related Art

Mobile telephone users often hand out their telephone number to co-workers, business clients, family, and friends. There are times when that user may want to have their mobile telephone turned on, but only for receiving emergency telephone calls and are not interested in receiving other types of calls. The problem can be generalized, recognizing that a user of a communications device, including a general purpose computing device that has a memory and a set of executable instructions in that memory (e.g., software), may at times wish to receive communications from one or more sets or types of sources, and may not want to immediately receive communications from other sources.

Some current mobile telephones permit the user to assign icons with individual entries in the mobile telephone's database of contacts, and some current mobile telephones permit different ring tones to be assigned to different contacts.

Some currently available email client software, including Microsoft Corporation's Outlook software, allows the software user to classify contact types or categories, e.g., business contacts, personal contacts, and the like, and to sort on those types. Some currently available email client software permits the user to define email filtering rules, some with Boolean logic, which can pre-sort email messages when received by the email client.

### SUMMARY OF THE INVENTION

According to a first aspect of the invention, a communication screening system useful in a communications device comprises logic configured to form a database of contact information records, each record including at least one class designator, logic configured to assign at least one mode to the communications device, at least one mode including at least one permitted class designation, at least one permitted class priority designation, or both, and logic configured to determine if a communication from a source corresponds to a contact record in the database having a class that is the same as said at least one permitted class designation of said at least one mode, or corresponds to a contact record in the database having a class priority at least as high as said at least one permitted class priority designation.

According to another aspect of the present invention, a communication screening system useful in a communications device comprises means for forming a database of contact information records, each record including at least one class designator, means for assigning at least one mode to the communications device, at least one mode including at least one permitted class designation, at least one permitted class priority designation, or both, and means for determining if a communication from a source corresponds to a contact record in the database having a class that is the same as said at least one permitted class designation of said at least one mode, or corresponds to a contact record in the database having a class priority at least as high as said at least one permitted class priority designation.

According to yet another aspect of the present invention, a method of screening a communication to a communications device comprises forming a database of contact information records, each record including at least one class designator, assigning at least one mode to the communications device, at least one mode including at least one permitted class designation, at least one permitted class priority designation, or both, and determining if a communication from a source corresponds to a contact record in the database having a class that is the same as said at least one permitted class designation of said at least one mode, or corresponds to a contact record in the database having a class priority at least as high as said at least one permitted class priority designation.

Still other aspects, features, and attendant advantages of the present invention will become apparent to those skilled in the art from a reading of the following detailed description of embodiments constructed in accordance therewith, taken in conjunction with the accompanying drawings.

### BRIEF DESCRIPTION OF THE DRAWINGS

The invention of the present application will now be described in more detail with reference to exemplary embodiments of the apparatus and method, given only by way of example, and with reference to the accompanying drawings, in which:

FIG. 1 illustrates a typical mobile telephone on which a system embodying principles of the present invention may be implemented;

FIG. 2 schematically illustrates in block diagram form a telephone with the elements of the system;

FIG. 3 schematically illustrates a database embodying principles of the present invention; and

FIG. 4 diagrammatically illustrates logic and processes embodying principles of the present invention.

### DETAILED DESCRIPTION OF EXEMPLARY EMBODIMENTS

Referring to the drawing figures, like reference numerals designate identical or corresponding elements throughout the several figures.

In general terms, the system 10 of the invention may be implemented as an integral part of a telephone so that it is physically inseparable from the telephone, but could also (less preferably) be implemented as a unit separate from the associated telephone. The system 10 may comprise a database which includes a plurality of contact information records. Each contact information record may in turn include a number of fields containing information relating to a contact. Each contact may represent a person, or a business, or other entity, having a telephone that may place calls to the user of the system 10. The contact may be associated with the person or entity through the telephone number of that person or entity (which is stored in the contact information record), and this may be the primary means of associating a contact with an incoming call (through matching of caller ID telephone number information transmitted with the call to telephone numbers in the contact records).

The fields of the contact information records may comprise one or more class fields that include, for example, information about the user's relationship to the contact or person associated with the contact information record. When incorporated into the logic of a communication device, the system 10 of the invention can be configured to automatically determine how a communication received from that contact by the communication device is to be routed or handled. The contact records in the database may be sorted by various criteria, such as by the classes designated in the contact information records. By way of non-limiting example, these criteria or classes could include, but not be limited to: Co-Worker, Boss, Emergency Contact, Family, Friends, etc. The system 10 can optionally be configured to assign or permit assignment of different priorities to different classes in the database.

The database is preferably stored in the local memory of the telephone on which the system 10 is implemented. A suitable telephone for the practice of the invention may be permanently wired (e.g., hard-wired) in a building, or may be a portable wireless telephone that, for example, relies upon a relatively short distance transmission system or that employs a cellular transmission system (although the invention may be employed with other types of systems). When another telephone, which has a telephone number, initiates a call to a telephone including features of the present invention, caller ID information associated with the calling telephone is received by the telephone and is compared to the fields of the contact information records of the local database and, if matched to one of the contact records, the system 10 of the telephone determines how to route or handle the call based on the class assigned to that contact in the associated contact information record. The system 10 is preferably configured to permit the user to place the system (and thus the operation of the telephone) in different operational modes that allow calls from some contacts to ring through the telephone, and calls from other contacts to be directed to an answering system, such as an answering machine, or mailbox engine.

Optionally, in the event that the caller ID information is not passed through to, or is not received by, the user's telephone associated with the system 10, the system may be configured to create a ‘backdoor’ path or process by which a caller of an incoming telephone call is able to enter and transmit an emergency code which causes the system 10 to bypass or override the class sorting procedure and permit the call to ring through the telephone.

Further optionally, the logic of the system 10 may be configured to permit the database of the system of the user's telephone to communicate and/or synch with a database located on another device to set the mode of the system 10. For example, the system 10 may be interfaced with a general purpose computer having a database in memory, to set the mode of the system of the user's telephone based on the user's schedule stored in the database on the computer. By way of example, and not of limitation, if the user has a day that has been designated as a vacation day in a calendar application, the logic of the system 10 may set the mode of the system to Vacation Mode on that day, which may thus permit only telephone calls associated with contacts of one or more classes (designated by the user) to ring through on the telephone. Further optionally, the system 10 of the telephone may be configured to redirect calls from classes (designated by the user) when received after a certain time of day (e.g., 6 P.M.) to, for example, an answering system, and this redirection may be avoided by those calls that originated from a telephone associated with a person having an “Emergency” designation in the contact information record corresponding to that person.

Of course, as alluded to above, the present invention is not limited to application to mobile telephone devices, and is similarly applicable to paging devices, e-mail software, personal digital assistant devices, POTS telephones, and any other kind of electronic communication, as will be readily appreciated from this description.

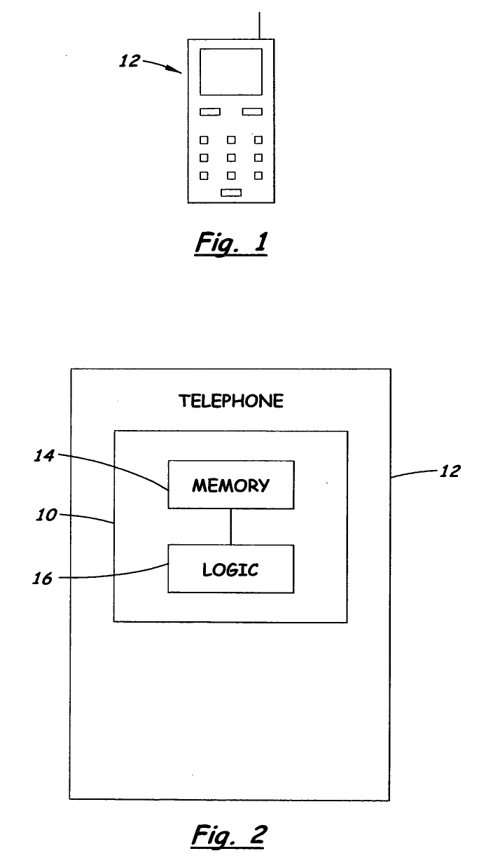

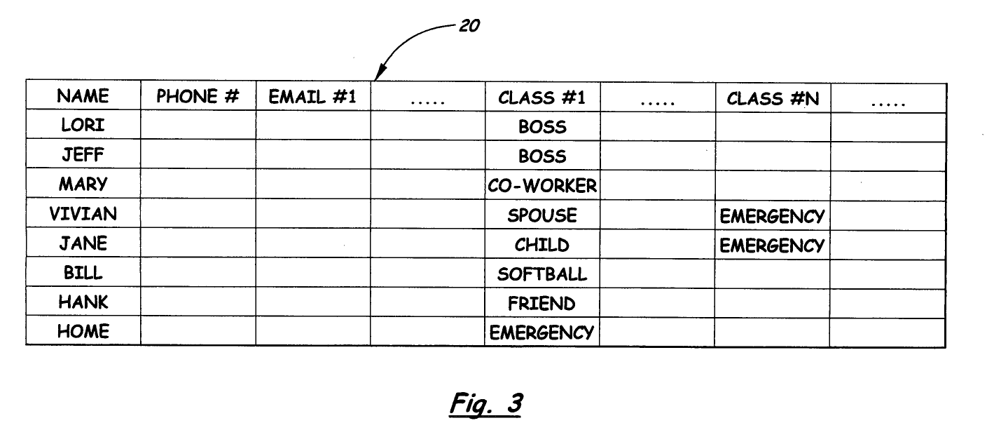

Turning now to the drawing figures, FIG. 1 schematically illustrates a mobile telephone 12 on which the system 10 may be implemented. FIG. 2 shows, in block form, various components of the telephone 12, including the system 10 with memory 14 and logic 16 configured in accordance with the present invention. More particularly, the database 20 (see FIG. 3) may reside on the memory 14 (see FIG. 2).

FIG. 3 illustrates portions of an illustrative database 20 in accordance with the present invention, embodying principles of the present invention. As will be readily appreciated by those of skill in the art, the logic of the communications device, e.g., mobile phone, is optionally configured to permit the entries in the database's records to be filled and edited. Each record in the database may include two or more elements, including but not limited to the name of a person associated with the contact, a telephone number of the person, one or more email addresses for the person, and other data of the types that are typically found in such databases. In accordance with the present invention, the database includes at least one, and preferably N (wherein N>1), class designators. These class designators can be predefined in the logic of the system 10, and/or can be user definable. For example, classes could include Emergency, Boss, Co-Worker, Spouse, Child, Football (team members), Friend, and the like. In preferred embodiments, a single contact, e.g., “Vivian”, can be in more than one class, e.g., “Spouse” and “Emergency”. Alternatively, classes can be assigned to have an attribute of, e.g., “Emergency”, so that assignment of “Vivian” to the class “Spouse” carries with it the attribute of “Emergency” contact.

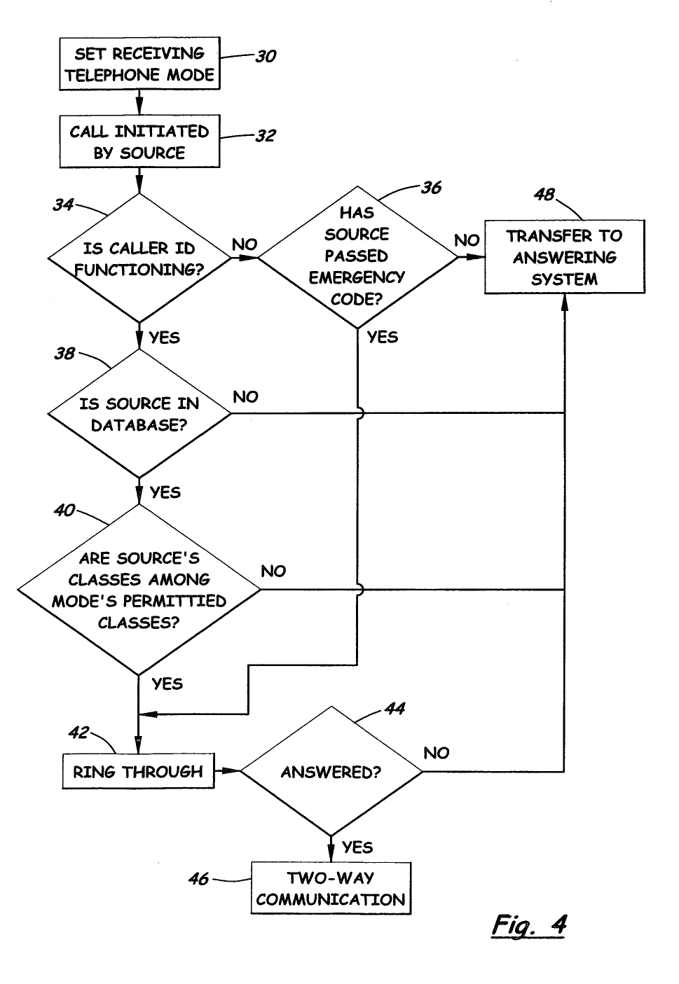

Turning now to FIG. 4, a flow chart of a logical process in accordance with the present invention is diagrammatically illustrated. The mode of the system 10 on the communication device (e.g., mobile telephone 12), is set (30). The mode may be set, for example, manually by the user or according to the user's schedule that has been retrieved by a synch operation as described elsewhere herein. Communication, such as a telephone call, is initiated by a source or caller (32). The system 10 of the telephone determines if caller ID data has been or is received for the call by the telephone 12 (34). If the caller ID data is not received by the telephone 12 and the system 10, the system 10 determines (36) if an emergency code has been passed or sent by the call initiator to permit the call to ring through (42) to the receiving telephone. If no such emergency code has been passed by the caller or received by the telephone 12, the incoming call is routed or transferred (48) to an answering system such as a voicemail, email, or other message system appropriate for the particular type of communication that was attempted.

When the caller ID is functioning (from 34) and the telephone has received the caller ID data, the system 10 compares (38) the telephone number from the caller ID data to the telephone numbers in the contact database, to determine if the source of the telephone call is listed in the database of contact information records. If a contact for the source of the telephone call is not in the database, the call is transferred to the answering system (48). If a contact corresponding to the source of the telephone call is in the database, the system compares (40) the class of source of the telephone call in the contact information records of the database to the classes defined by the receiving device's mode (from 30). If the class or classes associated with the source of the call corresponds to at least one class set to be passed through in the current mode, then the call is permitted to ring through (42) to the telephone. If the class or classes associated with the source of the call does not correspond to at least one class set to be passed through in the current mode, then the call is transferred to the answering system (48).

When the call has rung through to the telephone, if the call is answered (44), then communication (two-way communication, in the case of the example of a mobile phone) (46) can commence. If the call is not answered after a certain time or number of rings, the system transfers the call to the answering system (48) in a typical fashion.

A number of examples will help illuminate aspects of the present invention:

### EXAMPLE 1

the user sets the mobile telephone to “Work” mode, in which only calls with caller ID information containing telephone numbers contained in the contact information records of the contacts that are designated under “Work” can ring through to the mobile telephone.

### EXAMPLE 2

the user sets the mobile telephone to “Vacation” mode, in which only calls with caller ID information containing telephone numbers contained in the contact information records of the contacts that are designated under “Emergency” can ring through to the mobile telephone.

### EXAMPLE 3

the user is watching a movie and the device on which the movie is displayed has caller ID on a POTS line. While watching a movie, only calls with caller ID information containing telephone numbers contained in the contact information records of the contacts that have been designated “Emergency” class contacts show up on the caller ID on the TV; all other calls are routed to an answering system.

### EXAMPLE 4

A user goes to an apartment building and wants to be let into the building; the user calls the apartment, but has to identify himself or herself (e.g., by entering a PIN number). Depending on the mode to which the apartment dweller's telephone has been set, the system 10 associated with the apartment dweller's telephone could automatically play a recording that tells the visitor that the apartment dweller is not in, or the system 10 could permit the visitor talk to the apartment dweller.

Another optional feature of the present invention includes a “Block” class designation for the contact information records, by which a communication from a telephone number associated with a contact carrying this class designator is not permitted to pass through, and is routed immediately either to the answering system, of the call is terminated. Further optionally, the system may be configured to play a voice message (e.g., user-entered or predefined) that can be transmitted to the call originator bearing a “Block” class designation. In this optional configuration, the telephone (or other communications device), after determining that the call originator is in the “Block” class, accepts the call only to play the message and either transfer the call to the answering system or simply terminate the call. As a further option, the system 10 may be configured to treat all calls from telephone numbers not listed in the database as having a “Block” class designation.

Further optionally, the system 10 may be configured to permit each class to have a priority attribute, so that the class in which each contact is a member can be ranked according to their priority, and the system is configured to permit a mode to be set to permit calls to pass through based on the level of priority. For example, “Emergency” can be assigned a priority attribute of 10, while “Softball” can be assigned a priority attribute of 1; the logic of the system may be configured to permit the user to set a mode by which only call originating from contacts belonging to classes having priorities above a set level are rung through to the telephone. For example, setting a threshold priority level of 5 would send calls from contacts with a class designation of “Softball” (and a priority of 1) to the answering system and calls from contacts with a class designation of “Emergency” (and a priority of 10) to the telephone.

In yet another optional aspect of the present invention, the system 10 is configured to set the mode based upon calendar entries obtained from a synchronization operation with another computing device, or with another program installed on the system or the telephone, or from entries manually entered into a calendar database in the telephone itself. By way of non-limiting example, when the system 10 is synched with a calendar system contained in the memory of a general purpose computing device (e.g., personal computer, personal digital assistant, and the like), particular types of flags and/or schedule types, e.g., “vacation” or “business meeting” may be correlated with particular modes of the system. For example, when the calendar indicates that the user is on vacation, the system may be configured to set the mode to “vacation” during the vacation time block indicated from the calendar, and permit only calls originating from contacts having particular class designations to ring through. In a similar way, a “business meeting” flag in a calendar can set the mode to permit only classes such as “Boss” and “Emergency” to ring through. Similarly, the system may be optionally configured to be set to a “personal” mode during non-business hours and/or days, so that between, e.g., 6 PM and 7 AM the next morning of a workday, “Boss” and “Co-worker” do not ring through and “Spouse”, “Child”, “Friend”, “Softball”, and “Emergency” are permitted to ring through.

While the invention has been described in detail with reference to exemplary embodiments thereof, it will be apparent to one skilled in the art that various changes can be made, and equivalents employed, without departing from the scope of the invention. Each of the aforementioned documents is incorporated by reference herein in its entirety.

What is claimed is:

1. A communication screening system useful in a communications device, the system comprising:
logic configured to form a database of contact information records, each record including at least one class designator;
logic configured to assign at least one mode to the communications device, at least one mode including at least one permitted class designation, at least one permitted class priority designation, or both; and
logic configured to determine if a communication from a source corresponds to a contact record in the database having a class that is the same as said at least one permitted class designation of said at least one mode, or corresponds to a contact record in the database having a class priority at least as high as said at least one permitted class priority designation.

2. A communication screening system according to claim 1, wherein the logic configured to assign at least one mode to the communication device is further configured to assign at least one mode depending on the time of day, day of the week, or both.

3. A communication screening system according to claim 1, wherein the logic configured to determine is a communication from a source corresponds to a contact record is further configured to determine if caller ID data has been passed from the communication source.

4. A communication screening system according to claim 1, further comprising:
logic configured to transfer the communication to a message center upon determination that a class priority associated with a contact record in the database having a class priority that is not as least as high as said at least one permitted class priority designation.

5. A communication screening system according to claim 1, further comprising:
logic configured to determine if the communication source has passed an emergency code.

6. A communication device comprising a communication screening system according to claim 1.

7. A communication device according to claim 6, wherein said communication device is selected from the group consisting of a mobile telephone, a POTS telephone, a pager, and a personal digital assistant.

8. A communication screening system useful in a communications device, the system comprising:
means for forming a database of contact information records, each record including at least one class designator;
means for assigning at least one mode to the communications device, said at least one mode including at least one permitted class designation, at least one permitted class priority designation, or both; and
means for determining if a communication from a source corresponds to a contact record in the database having a class that is the same as said at least one permitted class designation of said at least one mode, or corresponds to a contact record in the database having a class priority at least as high as said at least one permitted class priority designation.

9. A communication screening system according to claim 8, wherein the means for assigning at least one mode sets said at least one mode based upon the time of day, day of the week, or both.

10. A communication screening system according to claim 8, further comprising:
means for determining if caller ID data has been passed from the communication source.

11. A communication screening system according to claim 8, wherein the means for determining if a communication from a source corresponds to a contact record in the database includes means for transferring the communication to a message center upon determination that a class priority associated with a contact record in the database having a class priority that is not as least as high as said at least one permitted class priority designation.

12. A communication screening system according to claim 8, further comprising:
means for determining if the communication source has passed an emergency code.

13. A communication device comprising a communication screening system according to claim 8.

14. A communication device according to claim 13, wherein said communication device is selected from the group consisting of a mobile telephone, a POTS telephone, a pager, and a personal digital assistant.

15. A method of screening a communication to a communications device, the method comprising:
forming a database of contact information records, each record including at least one class designator;
assigning at least one mode to the communications device, at least one mode including at least one permitted class designation, at least one permitted class priority designation, or both; and
determining if a communication from a source corresponds to a contact record in the database having a class that is the same as said at least one permitted class designation of said at least one mode, or corresponds to a contact record in the database having a class priority at least as high as said at least one permitted class priority designation.

16. A method of screening according to claim 15, further comprising:
assigning at least one mode depending on the time of day, day of the week, or both.

17. A method according to claim 15, further comprising:
determining if caller ID data has been passed from the communication source.

18. A method according to claim 15, further comprising:
transferring the communication to a message center upon determination that a class priority associated with a contact record in the database having a class priority that is not as least as high as said at least one permitted class priority designation.

19. A method according to claim 15, further comprising:
determining if the communication source has passed an emergency code.
